(19) United States
(12) Patent Application Publication
(10) Pub. No.: US 2019/0319933 A1
(43) Pub. Date: Oct. 17, 2019

(54) COOPERATIVE TLS ACCELERATION

(71) Applicant: ALIBABA GROUP HOLDING LIMITED, George Town (KY)

(72) Inventor: Xiaowei JIANG, San Mateo, CA (US)

(21) Appl. No.: 15/952,154

(22) Filed: Apr. 12, 2018

(51) Int. Cl. H04L 29/06; G06F 9/50

(52) U.S. Cl. CPC H04L 63/0428; G06F 9/5083; H04L 63/166

(57) ABSTRACT

An integrated circuit and a method for improving performance of cryptographic protocols in the performance of web services by making TLS operations efficient and also solving the unproportioned capacity issues surrounding front-end clusters of a data center is provided. The circuit comprises a peripheral interface configured to communicate with a host system comprising a host processor, a network adaptor configured to receive network packets in a secure session, a chip processor configured to execute a secure communication software stack to process the packets and to generate data load information of the chip processor, and a load balancer configured to acquire a notification in response to scheduling decisions and to redirect the packets based on the notification that a load of one of the host processor or the chip processor is determined to be overloaded.

### TECHNICAL FIELD

The present disclosure relates to methods and systems for improving performance of cryptographic protocols in the performance of web services.

### BACKGROUND

Transport Layer Security (TLS), or its equivalency Secure Sockets Layer (SSL), is a cryptographic protocol that provides confidentiality and authenticity to the communication between two end points over a network. The network may be a wireless or a wired LAN, WAN, Intranet, Internet, or the like. The end points may be a computing device such as a laptop, netbook or desktop computer, a cellular phone, a tablet such as an iPad or PDA, a server, a data processor, a work-station, a mainframe, a wearable computer such as a smart watch or computer clothing, and the like.

FIG. 1 illustrates a block diagram of an exemplary TLS stack 100. As seen, communication systems over a network may create a new layer (e.g., TLS, SSL, etc.) for a cryptographic protocol between application layer 110 and TCP/IP layer 120 of a conventional network stack 130. The purpose of this configuration is to provide encryption and decryption of network packets transferred over TCP/IP in order to protect against eavesdropping and tampering of the packets. Also, as seen, TSL stack 100 and application layer 110 are part of a user interface, while TCP/IP layer 120 is part of the kernel interface.

Cryptographic protocols like TLS may have a large computational overhead. In particular, TLS relies on public-key cryptography, for example Rivest-Shamir-Adleman (RSA) cryptosystem or Elliptic Curve, to establish a private session key agreed between two end points. TLS uses the private session key in a follow-on symmetric cryptography session, for example Advance Encryption Standard (AES). Symmetric and asymmetric ciphers used in TLS are known to have a large performance overhead that can slow down a web hosting service. Further and as shown in FIG. 1, since TLS 100 is built on top of the TCP/IP layer 120, the overhead of the TCP/IP protocol stack gets added to the overhead of a TLS protocol stack. By default, these protocol stacks are sequentially processed and are oftentimes branch-rich and are accordingly not hardware accelerative.

While some conventional solutions may provide hardware acceleration to TLS, these solutions (e.g., data center's front-end cluster architectures) are inefficient. For example, the aggregated Operation per Second (OPS) provided by the hardware usually cannot match the Connection per Second (CPS) provided by a host CPU when processing the rest of a TLS software stack. In the meantime, the aggregated CPS provided by a TLS acceleration cluster may also not be able to match the aggregated CPS provided by back-end application servers. This mismatch creates an unproportioned capacity provisioning issue surrounding front-end clusters of a data center.

### SUMMARY

Embodiments of the present disclosure provide an integrated circuit and a method performed by the integrated circuit for improving performance of cryptographic protocols of web services by making TLS operations more efficient. Moreover, the disclosed embodiments can assist with solving the unproportioned capacity issues surrounding front-end clusters of a data center.

Embodiments of the present disclosure also provide an integrated circuit comprising a peripheral interface configured to communicate with a host system comprising a host processor, a network adaptor configured to receive network packets in a secure communication session, a chip processor having one or more cores, wherein the chip processor is configured to execute a secure communication software stack to process network packets in the secure communication session, and a load balancer configured to redirect the received network packets based on a notification that a data load of one of the host processor or the chip processor is determined to be overloaded. The chip processor is further configured to generate data load information, wherein the data load information is provided to a scheduler to make a scheduling decision that is based on a data load of the host processor and a data load of the chip processor. The load balancer is further configured to acquire the notification in response to the scheduling decision.

The integrated circuit further comprising a secure communication engine configured to transfer a network stack task from the chip processor to the host processor based on a redirect instruction received from the load balancer. The load balancer is further configured to allow the secure communication engine to provide a software stack task to the host processor based on a determination that the data load of the chip processor is overloaded.

The integrated circuit further comprising a first controller on the chip processor configured to enable connectivity of the chip processor to the host processor for transferring the network stack task. The integrated circuit further comprising a second controller on the chip processor configured to permit the chip processor additional memory capacity provided by a peripheral interface card on the chip processor.

The secure communication engine comprises one or more sequencers configured to control cipher operations, and a plurality of tiles comprising one or more operation modules to assist with the cipher operations. Each of the one or more sequencers are configured to accept an acceleration request obtained from the load balancer, fetch cipher parameters of the request, break cipher operations into one or more arithmetic operations, and send each of the one or more arithmetic operations to the plurality of tiles for execution.

The integrated circuit further comprising an SDN controller configured to turn on the load balancer to start receiving network traffic from the network adapter. The load balancer includes a packet parser configured to evaluate header information of received network packets. The load balancer is further configured to include a packet parser configured to determine whether the received network packets are part of a secure communication session. The load balancer is further configured to in response to the determination that the received network packets are part of the secure communication session and a determination that the secure communication session is part of a new connection, update packet header information of network packets to be redirected.

Embodiments of the present disclosure also provide a method performed by an integrated circuit including a chip processor, wherein the integrated circuit communicates with a host system including a host processor, the method comprising receiving network packets in a secure communication session, executing a secure communication software stack to process network packets in the secure communication session, generating data load information of the chip processor, acquiring, based on the data load information of the chip processor and a data load of the host processor, information that one of the chip processor and the host processor is overloaded, and based on the information, redirecting network packets from the overloaded processor to the other processor.

The method, wherein acquiring information that one of the chip processor and the host processor is overloaded further comprising providing the data load information to a scheduler to make a scheduling decision based on the data load of the host processor and a data load of the chip processor and receiving a notification in response to the scheduling decision.

The method further comprising evaluating header information of the received network packets, and determining whether the received network packets are part of a secure communication session based on the evaluated header information. The evaluated header information is associated with at least one of destination MAC address, destination IP address associated with the chip processor, a source port, and a destination port.

The method further comprising determining whether the secure communication session is part of a new connection based on header information of the received network packets. In response to the notification, redirecting network packets from the overloaded processor to the other processor further comprises in response to determining that the received network packets are part of a secure communication session and that the secure communication session is part of a new connection, updating packet header information of network packets to be redirected. Updating packet header information of network packets to be redirected comprises updating at least one of destination IP address and destination MAC address of overloaded processor to at least one of destination IP address and destination MAC address of the other processor.

Additional objects and advantages of the disclosed embodiments will be set forth in part in the following description, and in part will be apparent from the description, or may be learned by practice of the embodiments. The objects and advantages of the disclosed embodiments may be realized and attained by the elements and combinations set forth in the claims.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 illustrates a block diagram of an exemplary TLS stack.

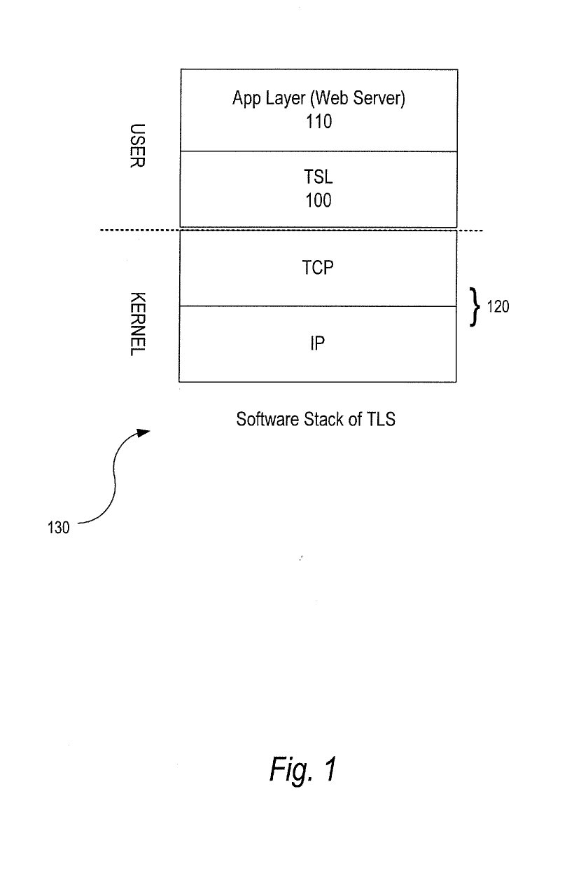

FIG. 2 a schematic diagram of a client-server system that includes an exemplary integrated circuit for improving performance of cryptographic protocols in the performance of web services, consistent with embodiments of the present disclosure.

FIG. 3 illustrates a schematic diagram of an exemplary sequence of a cryptographic protocol like TLS handshaking procedure, consistent with embodiments of the present disclosure.

FIG. 4 illustrates a block diagram of an exemplary data center front-end architecture with TLS acceleration support, consistent with embodiments of the present disclosure.

FIG. 5A depicts a block diagram of an exemplary integrated circuit architecture, consistent with embodiments of the present disclosure.

FIG. 5B depicts a block diagram of an exemplary TLS engine architecture, consistent with embodiments of the present disclosure.

FIG. 6 illustrates a block diagram of an exemplary consolidation of TLS clusters and App clusters in front-end servers of a data center, consistent with embodiments of the present disclosure.

FIG. 7 illustrates an exemplary design of a load balancer, consistent with embodiments of the present disclosure.

FIG. 8 is a flowchart illustrating exemplary operation for initiating a load balancer operation, consistent with embodiments of the present disclosure.

FIG. 9 is a flowchart illustrating exemplary steps of a load balancer operation, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of a processing system, a method, and a non-transitory computer-readable medium related to the subject matter recited in the appended claims.

Cryptographic protocols (e.g., TLS, SSL, etc.) rely on public-key cryptography to establish a private session key agreed between two parties. For example, TLS handshaking is a process for a server and a client to authenticate each other and reach an agreement on a private session key. The session going forward between the server and client is encrypted using the private session key. It is appreciated that the cryptographic protocols discussed in the present disclosure may be carried out in the TLS, SSL, or other comparable layer in a network stack capable of encrypting and decrypting network packets transferred over TCP/IP.

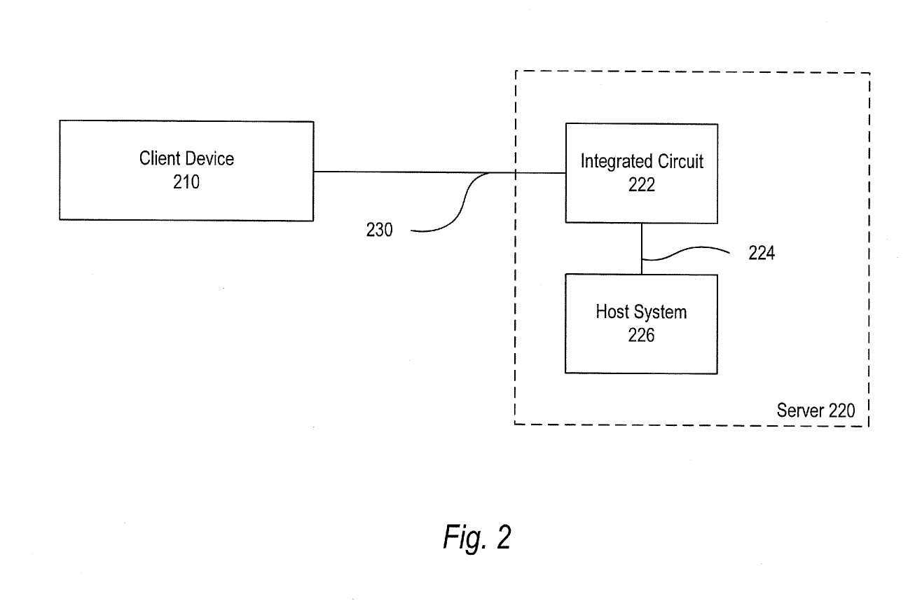

FIG. 2 is a schematic diagram of a client-server system that includes an exemplary integrated circuit for improving performance of cryptographic protocols in the performance of web services, in accordance with some embodiments disclosed in this application. Referring to FIG. 2, a client device 210 may connect to a server 220 through a communication channel 230. Communication channel 230 may be secured using a secure communication mechanism such as TLS. Server 220 may include a host system 226 and an integrated circuit 222. Host system 226 may include a web server, a cloud computing server, or the like. Integrated circuit 222 may be coupled to host system 226 through a peripheral interface connection 224. Peripheral interface connection 224 may be based on a parallel interface (e.g., Peripheral Component Interconnect (PCI) interface), a serial interface (e.g., Peripheral Component Interconnect Express (PCIe) interface), etc. TLS related cryptographic protocols in the performance of web services, often computationally intensive, may be performed by integrated circuit 222. As a result, the performance overhead normally imposed on host system 226 can be relieved by offloading the secure communication operations to integrated circuit 222. Further, by incorporating processor cores in integrated circuit 222, a comprehensive offload that not only offloads the cipher computation, but also offloads the entire TLS software stack are provided. Furthermore, and by default, a host system processor does not need to actively participate in any part of TLS operation. Therefore, the host processor is free to run tasks in app clusters, and accordingly allow consolidation of TLS clusters and app clusters in conventional front-end clusters, reducing the need of a substantial number of servers.

Communications between integrated circuit 222 and host system 226 may be plain text-based, while communications between server 220 and client device 210 may be encrypted and secured by operations of integrated circuit 222.

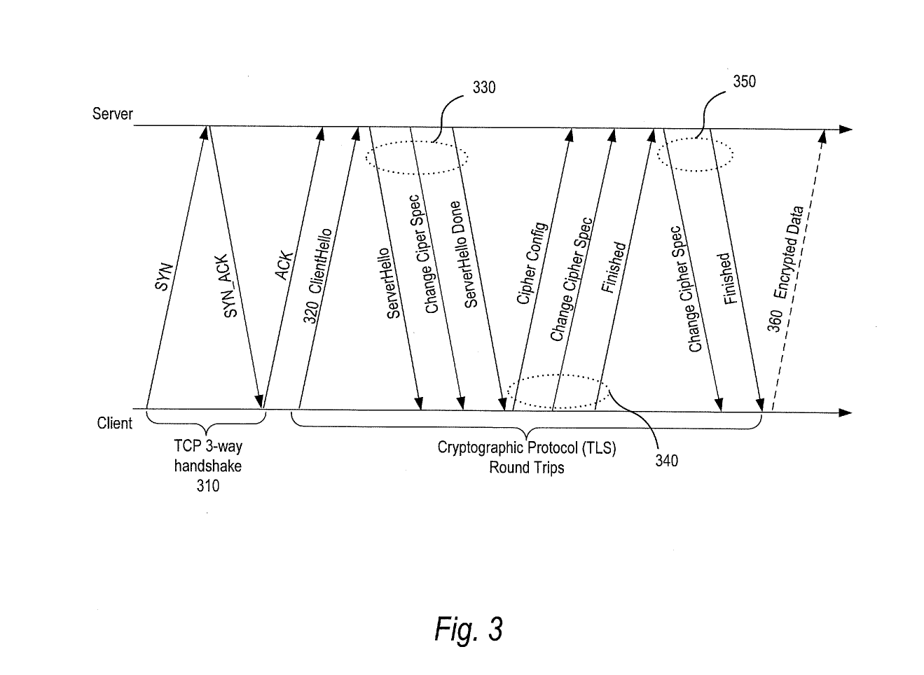

FIG. 3 illustrates a schematic diagram of an exemplary sequence of a cryptographic protocol, for example TLS, handshaking procedure, consistent with embodiments of the present disclosure. While the embodiments described herein are generally directed to the TLS and/or SSL cryptographic protocols, it is appreciated that other comparable cryptographic protocols that are capable of encrypting and decrypting network packets transferred over TCP/IP can be used.

At sequence 310, a TCP 3-way handshake occurs where a client sends a SYN message to a server followed by the server sending a SYN_ACK message to the client followed by the client sending an ACK message to the server. At sequence 320, the client sends a Client_Hello message to the server. The Client_Hello message may include an SSL version number that the client supports, a client-side random number (Rc), the cipher suite and compression methods that the client supports.

At sequence 330, the server responds with a Server_Hello message. The Server_Hello message may include a SSL version number, a server-side random number (Rs), cipher suites and compression methods that the server supports. The server response also may include the server's certificate (Change Cipher Spec) that contains the public key (e,n). Finally, a Server_Hello Done message indicates the end of the Server_Hello and its associated messages.

At sequence 340, the client authenticates the server's certificate (Cipher Config) and sends a pre_master_secret (Change Cipher Spec) message. A Finished message indicates the end of client-side negotiation. This sequence of messages is encrypted with the server's public key by calculating msgΛe mod n.

At sequence 350, the server decrypts the client's message using its private key (d,n) by calculating msgΛd mod n (Change Cipher Spec), and responds with a Finished message indicating the end of server side negotiation. At this point, the server and client have reached an agreement on pre_master_secret and can both derive the same session key master_secret using a Pseudo Random Function (PRF). Sequences 320, 330, 340, and 350 are used for secure communications, for example using TLS cryptographic protocol, round trips performed prior to the client sending data messages to the server. The session between the client and the server going forward will be encrypted using the session key master_secret and the agreed upon private-key cipher (such as AES). Accordingly, at 360, the client sends the server an encrypted data message (Encrypted Data).

These cryptographic protocols may then use the public-key cryptography in a follow-on symmetric cryptography session, when both symmetric and asymmetric ciphers used in these protocols have performance overhead that may slow down the web hosting service, for example by over 800%. For example, while providing confidentiality and authenticity, cryptographic protocols like TLS add significant latencies to the application services, such as web servers that use it. This results in a tremendous impact on both the query latency and Query per Second (QPS) that can be supported by the web servers.

The overhead incurred by a cryptographic protocol like TLS on the server side can be broken down into cryptographic computation and networking stack processing. During cryptographic computation, the asymmetric private key decryption with large key length (e.g. 2048 bits or 4096 bits) may consume tens to hundreds of milliseconds on conventional processor architectures. These computations happen in the pre-master secret derivation as well as in the transient public key generation in an ephemeral key exchange. Likewise, the symmetric key encryption and decryption that occurs to every packet after session establishment can also be a show stopper to server performance.

For networking stack processing, TLS packets flow through regular networking layers before the packets are delivered to a TLS or SSL layer. This includes the packet send/receive procedure and TCP/IP processing in the kernel. The processing in the TCP and IP networking layers also adds extra latencies to supporting TLS. Once delivered, the code that implements the TLS protocol layer itself, such as OpenSSL, may further add millions of processor instructions, which exclude the cryptographic computation.

Therefore, conventional hyper-scale data centers are introducing dedicated clusters of servers at its front-end to deal with the overheads associated with TLS. These servers are often equipped with commercial TLS accelerator cards. These conventional solutions provide hardware acceleration to the cipher algorithms (cryptographic computation overhead discussed above), while the networking stack itself is still left running on the host processors of servers.

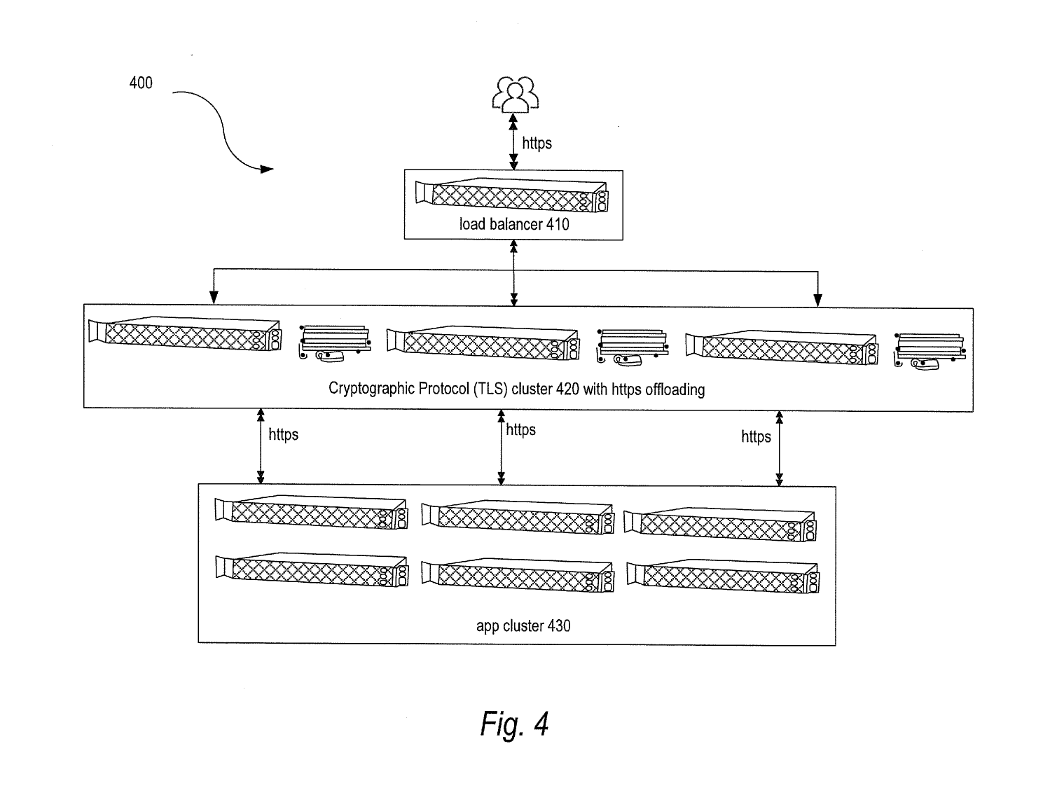

FIG. 4 illustrates a block diagram of an exemplary data center front-end architecture 400 with TLS acceleration support, consistent with embodiments of the present disclosure. Data center front-end architecture 400 may include a load balancer 410, a cryptographic protocol like TLS cluster 420, and an app cluster 430. Various clusters in data centers are provisioned to provide comparable capacity among each other. In particular, in the architecture shown in FIG. 4, certain criteria must be met when provisioning the capacity of TLS cluster 420 and app cluster 430.

First, the aggregated sustainable CPS of TLS cluster 420 must at least match against the aggregated sustainable QPS of app cluster 430. Second, the aggregated sustainable CPS provided by the processors in TLS cluster 420 in handling networking stack must at least match against the aggregated OPS provided by the one or more TLS accelerators. And third, the CPS provided by the processor of an individual server n TLS cluster 420 in handling networking stack must at least match against the OPS provided by the one or more TLS accelerators in that server.

Practically, meeting the above three criteria at the same time may be infeasible. This is because a system of three equations is being solved with two variables, i.e., the number of servers in TLS cluster 420 and the number of servers in app cluster 430. The OPS provided by the one or more TLS accelerators is also not necessarily designed in line with the CPS of the processor in TLS cluster 420 handling a networking stack. As a consequence, the compute capacity in these front-end TLS clusters may oftentimes be un-proportionally provisioned one way or another.

Accordingly, the present disclosure includes embodiments that improve the performance of cryptographic-protocol operations that hamper the performance of web services by making these operations more efficient. Moreover, the embodiments of the present disclosure can assist with solving unproportioned capacity issues surrounding front-end clusters of a data center.

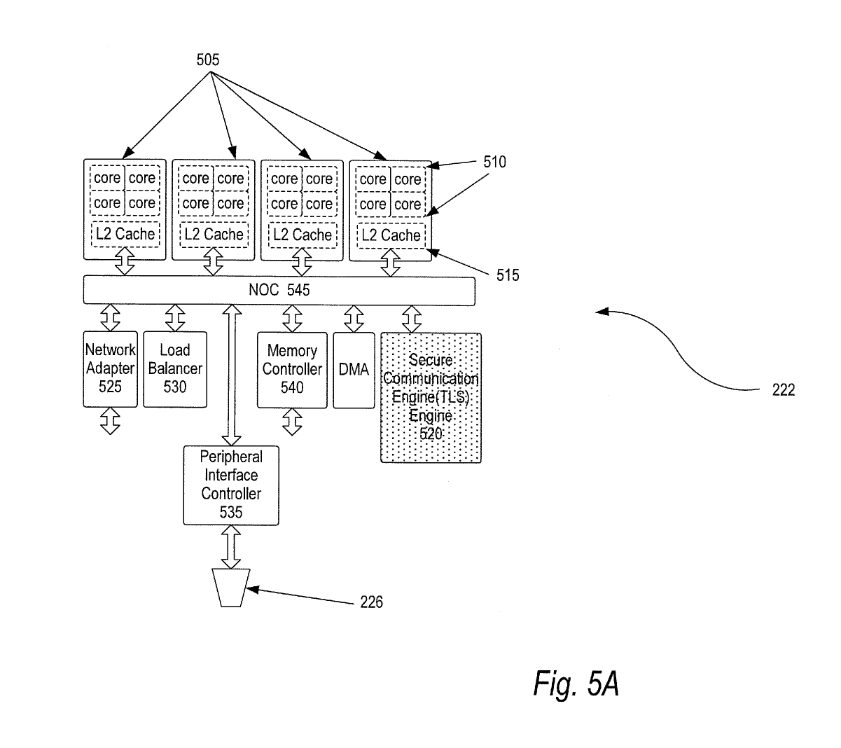

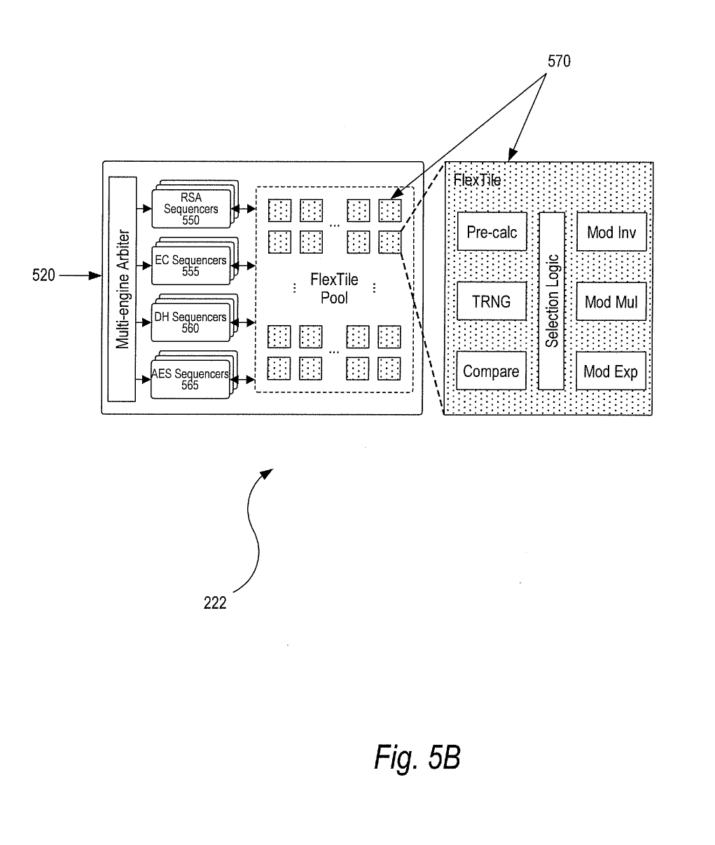

FIG. 5A depicts a block diagram of an exemplary integrated circuit architecture, for example integrated circuit 222, consistent with embodiments of the present disclosure. As shown in FIG. 5A, the integrated circuit architecture 222 may include a multi-core system that includes a group of processors 505 each having one or more processor cores 510 and a layer 2 cache (L2 cache) 515. Integrated circuit architecture 222 may also include a secure communication engine 520 (e.g., a TLS cipher acceleration engine), a network adaptor 525, as well as a load balancer 530. Integrated circuit architecture 222 is intended to be incorporated in a PCIe card that gets plugged into a host system, for example host system 226, and thus, a peripheral interface controller such as PCIe controller 535 (within the PCIe card) is also augmented into the integrated circuit chip to enable the connectivity to a processor on host system 226. A memory controller 540 is included in the integrated circuit to allow the various components in the integrated circuit to enjoy a full memory capacity provided through a local DRAM equipped on the PCIe card. All the components in the integrated circuit are interconnected with each other through a Network-on-Chip (NoC) fabric 545.

In operation, network adaptor 525 replaces the role of a conventional Network Interface Card (NIC) in a server. Packets received on the Ethernet port of the NIC are processed by network adaptor 525 in layer-1 (physical layer) and layer-2 (data-link layer) of the networking stack. The packets are then forwarded to the processor cores 510 in the integrated circuit for further processing by the rest of the networking stacks. According to some embodiments, by incorporating processor cores 510 in the integrated circuit, a comprehensive offload that not only offloads the cipher computation, but also offloads the entire TLS software stack are provided.

According to some embodiments, a host processor (for example a CPU on host system 226) no longer actively participates in any part of the TLS operation by default. Therefore, the host processor is free to run tasks in app clusters, and accordingly allow consolidation of TLS clusters and app clusters in conventional front-end clusters, reducing the need of a substantial number of servers.

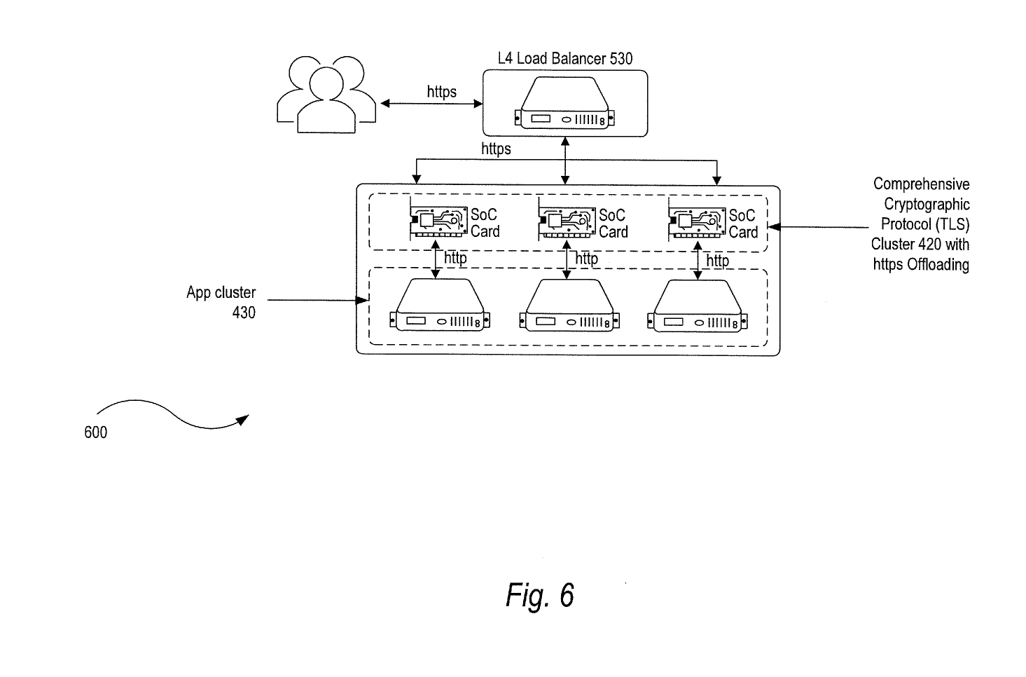

FIG. 6 illustrates a block diagram 600 of an exemplary consolidation of comprehensive cryptographic protocol clusters or TLS clusters and app clusters in a front-end server, for example front-end server 400 of a data center, consistent with embodiments of the present disclosure. According to some embodiments, a L4 hardware load balancer, for example load balancer 530 of FIG. 5A is incorporated into the integrated circuit, for example integrated circuit 222. This incorporation allows secure communication engine 520 (which can act as a TLS integrated circuit accelerator) to spill out the networking stack processing task from the integrated circuit's one or more processor cores, for example processor cores 510 to the host processor in the server, for example server 226, and accordingly can flexibly balance out the load on networking stack processing. According to another embodiment, load balancer 530 speaks OpenFlow protocol with the control plane code that runs on either the integrated circuit's processor or on the host processor, ensuring an optimal availability for matching the OPS of the TLS engine 520, the CPS of TLS related networking processing, and the CPS of the application servers, i.e., the three criteria discussed previously. FIG. 6 also illustrates a comprehensive cryptographic protocol (or TLS) cluster with https offloading capability, for example cluster 420 and a number of servers in an app cluster, for example cluster 430.

In operation, telemetry or statistics of certain hardware events is provided by servers, peripheral devices, etc. in a data center. This telemetry is collected by monitoring/scheduling systems and components that will make appropriate scheduling/load-balancing decisions based on the telemetry. For example, a monitor (not shown), which resides on every server, collects the statistics by the server, peripheral devices, etc. and provides input (e.g., the statistics or an indication that one of the nodes is overloaded) to a cluster scheduler (not shown). Using this input from each of the nodes, the cluster scheduler can make data scheduling decisions for load balancing purposes. It is appreciated that the cluster scheduler can reside anywhere within cluster 420.

As shown in FIG. 5A, integrated circuit 222 includes a secure communication engine 520 that provides hardware acceleration to cipher algorithms used in cryptographic protocols such as TLS. As shown in FIG. 5B, TLS engine 520 may be designed with a plurality of tiles called FlexTile 570 (dotted squares in FIG. 5B). Each tile in the TLS engine may contain a complete set of basic operation modules to run basic arithmetic operations needed by cipher algorithms such as RSA, Diffie-Hellman, Elliptical Curve, and the like. These arithmetic operations may include modular multiplication, modular exponentiation, pre-calculation, true random number generation, comparison, and the like. Each tile in the TLS engine comprises a number of these arithmetic units as well as a set of selection logic that allows the tiles to selectively activate functional modules based on commands sent from a sequencer.

TLS engine 520 may also include four sequencers, namely RSA 550, EC 555, Diffie-Hellman (DH) 560, and AES 565, each capable of independently controlling the operations for a corresponding cipher algorithm. Each sequencer is responsible for accepting the TLS acceleration request, fetching its cipher parameters, breaking the cipher operation into a series of its underlying arithmetic operations, and sending the operations to a FlexTile, for example FlexTile 570 for execution.

According to some embodiments, in order to allow more flexibility in capacity provisioning, the host processor may also be allowed to participate in the networking stack processing and balancing out the load on the integrated circuit's processor. This is particularly useful when the integrated circuit's processor is heavily loaded, but the host processor and the secure communication engine or TLS engine module are still underutilized, and vice versa. The approach of letting the host processor participate in the networking stack processing and balancing out the load on the integrated circuit's processor, introduces one more variable into the system of three equations with two variables defined previously. Now it is possible to making the equation solvable and proportional capacity provisioning may be achieved.

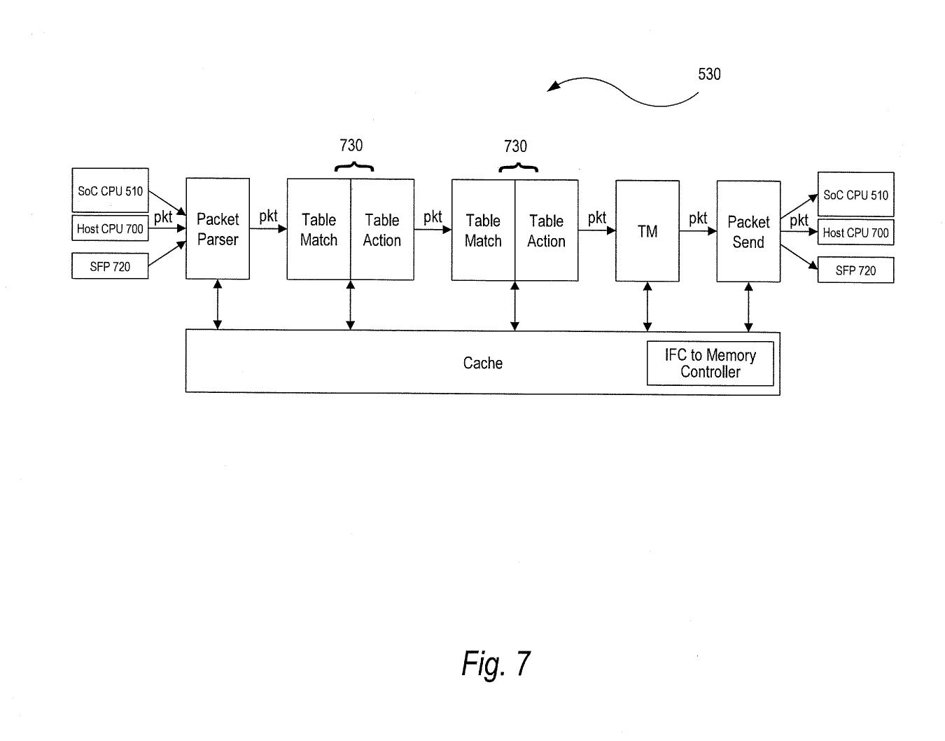

FIG. 7 illustrates an exemplary design of a load balancer, for example load balancer 530 illustrated in FIG. 5A, consistent with embodiments of the present disclosure. Load balancer 530 is responsible for balancing out TLS or SSL related traffic. Load balancer 530 is similar to a simplified OpenFlow software-defined networking (SDN) switch. The balancer receives no network traffic, i.e., data packets, when turned off, and when turned on, it receives network traffic from the network adaptor (e.g., network adaptor 525 of FIG. 5A). Ingress traffic, i.e., data packets, can come from three ports, namely host processor (host CPU) 700, for example in host system 226, a processor core, for example processor core (SoC CPU) 510 in the integrated circuit 222, and a small form-factor pluggable (SFP) Ethernet port 720. Traffic flows through a series of OpenFlow tables 730 that are programmed by an SDN controller (not shown) running on either the integrated circuit's processor (SoC CPU) 510 or the host processor 700. Traffic is illustrated by a series of one-directional arrows marked “pkt”.

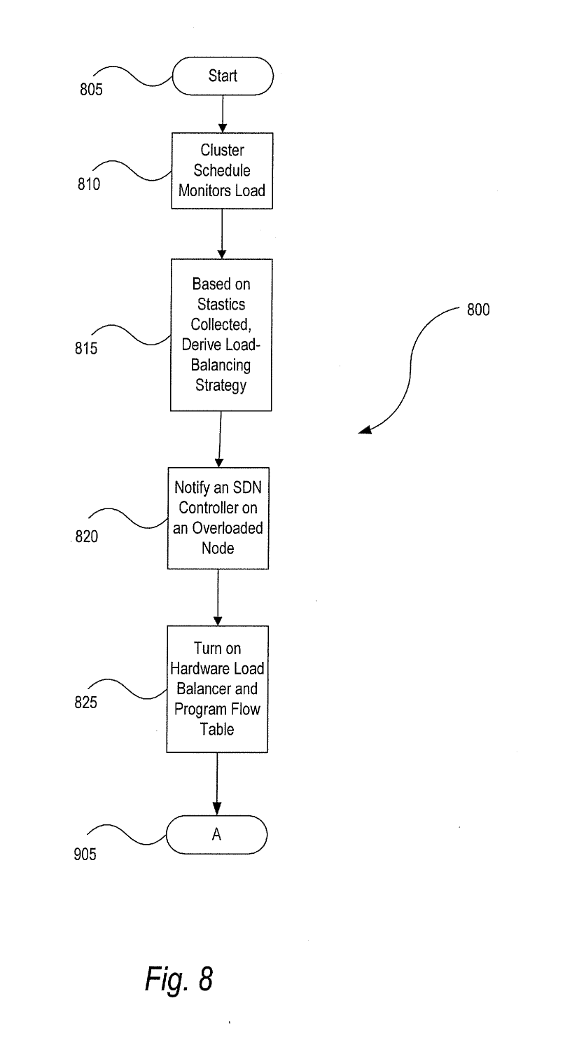

FIG. 8 is a flowchart illustrating exemplary operation 800 for initiating a load balancer operation (discussed later), consistent with embodiments of the present disclosure. It is appreciated that the initiation of the load balancer is performed by an integrated circuit (e.g., integrated circuit 222 of FIG. 5A). After the initial start step 805, at step 810, a cluster scheduler monitors the loads on a host processor (e.g., host CPU 700), and a secure communication engine (e.g., secure communication engine 520), in the integrated circuit card on each node in the cluster. As noted, telemetry or statistics of certain hardware events is provided by servers, peripheral devices, etc. in a data center. This telemetry is collected by monitoring/scheduling systems and components that will make appropriate scheduling/load-balancing decisions based on the telemetry.

Based on the statistics collected, the cluster scheduler derives a load-balancing strategy at step 815 based on a determination that the integrated circuit processor core or the host processor are overloaded. Base on the determination that one of these nodes is overloaded, at step 820, the cluster scheduler provides an indication to an SDN controller on the overloaded node to trigger load balancing.

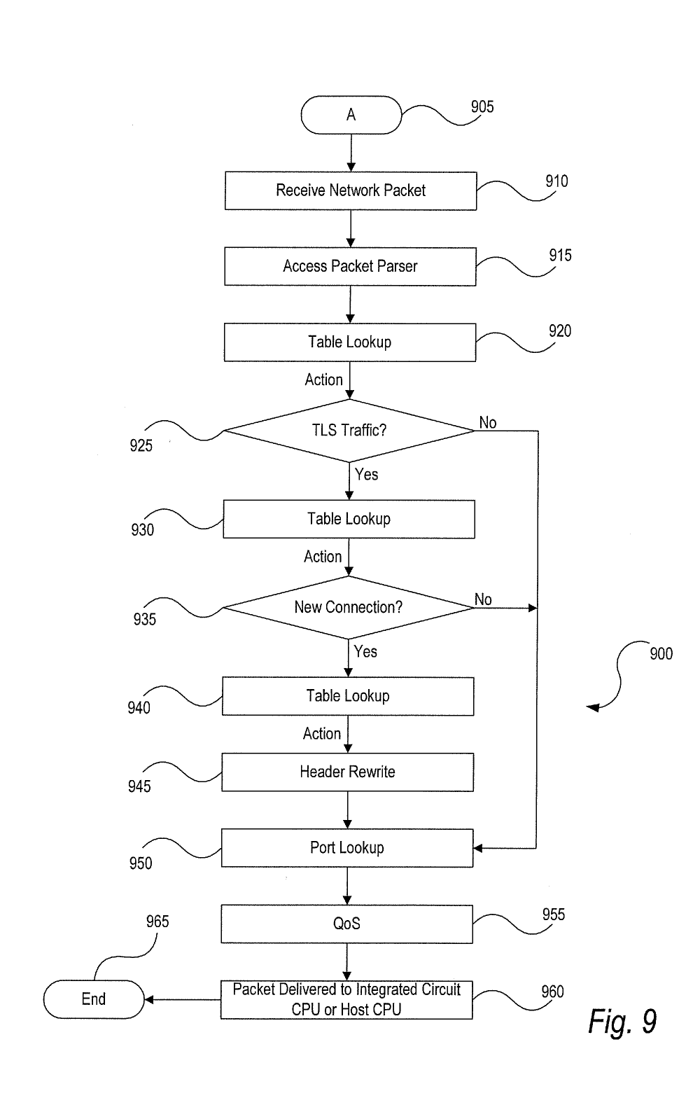

Next, at step 825, the SDN controller that runs on the overloaded node (either host processor 700 or the integrated circuit's small processor core 510) turns on the integrated circuit hardware load balancer (e.g., load balancer 530 of FIG. 5A). The SDN controller can also program its flow table in the load balancer where traffic (i.e., data packets, for example pkt in FIG. 7) can be redirected, according to the scheduler's load-balancing strategy. Once turned on, the load balancer starts to receive network traffic from a network adaptor (e.g., network adaptor 525) in the integrated circuit. The operation ends at step A, which continues on to FIG. 9.

FIG. 9 is a flowchart illustrating exemplary steps of a load balancer operation 900, consistent with embodiments of the present disclosure. After initial step 905, (e.g., step A of FIG. 8), at step 910, load balancer starts to receive network traffic from a network adaptor (e.g., network adaptor 525) in the integrated circuit.

Data packets flowing into the load balancer may first go through a packet parser to extract its packet header, at step 915. The load balancer processes the packet header in chained OpenFlow tables that are programmed by the SDN controller miming on the overloaded node (integrated circuit's processor or the host processor, depending on the configuration). For example, the SDN controller may provide instructions for load balance to process the packet header by analysing the packet's destination MAC address, destination IP address for a processor core, destination port number (e.g., TLS port), etc. Besides identifying which fields to use, the SDN controller can also instruct the load balancer to use a particular lookup function (e.g., Exact Match or Longest-Prefix Match), and performing actions associated in the entries of the table. Accordingly, the SDN controller code is software manageable, which allows more flexibility for the cluster scheduler to explore its strategy.

After parsing the packet, at step 920, the load balancer performs a table lookup. The table lookup may use a common 5-tuple hashing Based on the table lookup, at step 925, the load balance may determine if the flow is TLS related traffic (e.g., if a port in the packet header is a TLS port). If the flow is not TLS-related, the load balancing operation proceeds to step 950 where a port lookup is performed for sending the flow out to the egress port at step 960 (via step 955).

On the other hand, if the flow is TLS-related traffic, a TLS connection is identified and load balancing processing continues with a second table lookup at step 930 to determine if the data packet is communicated over a new connection. For example, this lookup may use TCP-status fields provided in the packet header. These fields may include, but are not limited to, fields URG, SYN, FIN, ACK, PSH, RST. Using this field information, the load balancer may perform a table lookup in a second table of the chain OpenFlow tables.

Based on the second table lookup, at step 935, the load balancer determines whether the data packet is communicated over a new connection. For an already established TCP connection (i.e., there is not a new connection), no traffic redirecting is taken as the TLS session is built on top of TCP connections in order to maintain session secrecy with the same processor. Therefore, for an already established TCP connection, the load balancing operation proceeds to step 950 where a port lookup is performed for sending the data packet flow out to the egress port to the corresponding processor part of the TCP connection.

If a new TLS connection is identified at step 935, load balancing processing continues with a third table lookup at step 940 for assisting with a redirect action of a header rewrite. This third table lookup may use the data packet's field information to access a third OpenFlow table of the chain of OpenFlow tables. The field information can include source IP address/port number, destination IP address/port number, the protocol, or any other data referring to the session connection for a 5-tuple match with the table. The results of the third table lookup acts as a Source Network Address Translation (SNAT) or Destination Network Address Translation (DNAT).

Using the results of the third table lookup, at step 945, the header of the data packet is rewritten. For example, flows that are intended to be sent to the small processor core in the integrated circuit will now have their destination IP address and MAC address rewritten to the IP address and MAC address of the host processor.

Next, the packet, which may have a header rewrite (depending on the results of determination steps 925 and 935), is ready to be sent over a network. A port lookup is conducted at step 950. The port lookup may be based on results of a 5-tuple match into a port table to determine which port the packet is intended to be sent. For example, the ports affiliated with the host processor, the integrated circuit's processor and the Ethernet port on the integrated circuit card may be selected.

Next, at step 955 the load balancer can perform quality of service (QoS) processing on the packet. Using a QoS policy, the integrated circuit may perform rate limiting on the designated port. At step 960, the data packet is delivered to the designated port, for example the integrated circuit processor or host processor. The operation ends at step 965.

In operation, if the data packets are redirected from the integrated circuit's processor to the host processor, the host processor performs the networking stack processing on behalf of the integrated circuit's processor. Since the TLS engine in the integrated circuit is also accessible as a PCIe device to the host processor, the host processor can offload the cipher computation to the TLS engine to speed things up. This way the traffic is balanced out between the integrated circuit's processor and the host processor, making it much easier to allocate resources to match the three proportional capacity provisioning criteria of the TLS clusters and app clusters referred to earlier.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

1. An integrated circuit comprising:
a peripheral interface configured to communicate with a host system comprising a host processor;
a network adaptor configured to receive network packets in a secure communication session;
a chip processor having one or more cores, wherein the chip processor is configured to execute a secure communication software stack to process network packets in the secure communication session; and
a load balancer configured to redirect the received network packets based on a notification that a data load of one of the host processor and the chip processor is determined to be overloaded.

2. The integrated circuit of claim 1, wherein the chip processor is further configured to generate data load information of the chip processor, wherein the data load information is provided to a scheduler to make a scheduling decision that is based on a data load of the host processor and a data load of the chip processor.

3. The integrated circuit of claim 2, wherein the load balancer is further configured to acquire the notification in response to the scheduling decision.

4. The integrated circuit of claim 1, further comprising:
a secure communication engine configured to transfer a network stack task from the chip processor to the host processor based on a redirect instruction received from the load balancer.

5. The integrated circuit of claims 1, wherein the load balancer is further configured to allow the secure communication engine to provide a software stack task to the host processor based on a determination that the data load of the chip processor is overloaded.

6. The integrated circuit of claim 5, further comprising a first controller on the chip processor configured to enable connectivity of the chip processor to the host processor for transferring the network stack task.

7. The integrated circuit of claim 5, further comprising a second controller on the chip processor configured to permit the chip processor additional memory capacity provided by a peripheral interface card on the chip processor.

8. The integrated circuit of claims 4, wherein the secure communication engine comprises:
one or more sequencers configured to control cipher operations, and
a plurality of tiles comprising one or more operation modules to assist with the cipher operations.

9. The integrated circuit of claim 8, wherein each of the one or more sequencers are configured to:
accept an acceleration request obtained from the load balancer;
fetch cipher parameters of the request;
break cipher operations into one or more arithmetic operations; and
send each of the one or more arithmetic operations to the plurality of tiles for execution.

10. The integrated circuit of claim 1 further comprising
an SDN controller configured to turn on the load balancer to start receiving network traffic from the network adapter.

11. The integrated circuit of claim 1,
wherein the load balancer includes a packet parser configured to evaluate header information of received network packets.

12. The integrated circuit of claim 11, wherein the load balancer is further configured to include a packet parser configured to determine whether the received network packets are part of a secure communication session.

13. The integrated circuit of claim 12, wherein the load balancer is further configured to in response to the determination that the received network packets are part of the secure communication session and a determination that the secure communication session is part of a new connection, update packet header information of network packets to be redirected.

14. A method performed by an integrated circuit including a chip processor, wherein the integrated circuit communicates with a host system including a host processor, the method comprising:
receiving network packets in a secure communication session;
executing a secure communication software stack to process network packets in the secure communication session;
generating data load information of the chip processor;
acquiring, based on the data load information of the chip processor and a data load of the host processor, information that one of the chip processor and the host processor is overloaded; and
based on the information, redirecting network packets from the overloaded processor to the other processor.

15. The method of claim 14, wherein acquiring information that one of the chip processor and the host processor is overloaded further comprises:
providing the data load information to a scheduler to make a scheduling decision based on the data load of the host processor and a data load of the chip processor; and
receiving a notification in response to the scheduling decision.

16. The method of claim 14, further comprising:
evaluating header information of the received network packets; and
determining whether the received network packets are part of a secure communication session based on the evaluated header information.

17. The method of claim 16, wherein the evaluated header information is associated with at least one of destination MAC address, destination IP address associated with the chip processor, a source port, and a destination port.

18. The method of claim 16, further comprising:
determining whether the secure communication session is part of a new connection based on the header information of the received network packets.

19. The method of claim 14, wherein in response to acquiring information, redirecting network packets from the overloaded processor to the other processor further comprises:
in response to determining that the received network packets are part of a secure communication session and that the secure communication session is part of a new connection, updating packet header information of network packets to be redirected.

20. The method of claim 19 wherein updating packet header information of network packets to be redirected comprises updating at least one of destination IP address and destination MAC address of overloaded processor to at least one of destination IP address and destination MAC address of the other processor.
